(19) United States
(12) Patent Application Publication
(10) Pub. No.: US 2007/0266681 A1
(43) Pub. Date: Nov. 22, 2007

(54) Filter mounting structure and method

(75) Inventors: Jerry Alan Grey, Shawnee, KS (US); Carl Lynn Hemeyer, Slater, MO (US)

Correspondence Address: Ernest G. Cusick;GE Infrastructure, Energy, Bldg 37 - Room 568, One River Road, Schenectady, NY, 12345, US

(73) Assignee: BHA Group, Inc.

(21) Appl. No.: 11/437,144

(22) Filed: May 19, 2006

(51) Int. Cl. B01D 46/00

(52) U.S. Cl. 55/378

(57) ABSTRACT

One aspect of the invention is directed to a filter assembly for use in a baghouse having a tubesheet with a plurality of thimbles each having a beaded portion. The filter assembly comprises a cylindrical filter bag having an axial end portion formed into a cuff. The cuff of the filter bag is adapted to be positioned within the thimble. The filter assembly also includes mounting structure adapted to be located within the cuff of the filter bag to mount the filter bag relative to a respective thimble of the tubesheet. The mounting structure comprises an annular gasket. The gasket includes a bead portion. The mounting structure also includes a resilient snapband for exerting a force to expand the gasket outward and seat the bead portion of the gasket within a beaded portion of the thimble to form a seal.

### BACKGROUND OF THE INVENTION

1. Field of the Invention

The invention is generally directed to a filter assembly for use in a dust collector. In particular, the invention is directed to a filter bag and structure for mounting and attaching the filter bag in the dust collector. The invention is also directed to a method of installing the filter assembly in the dust collector.

2. Description of the Prior Art

Dust collectors, such as baghouses, for filtering particulate-laden gas streams are known. A typical “reverse air” baghouse has a housing with an inlet chamber and an outlet chamber. The two chambers are separated by sheet metal, commonly referred to as a tubesheet, that is typically located in the lower area of the baghouse. The tubesheet has a number of openings around which beaded thimbles are welded. Filter assemblies are supported in the baghouse.

Each of the filter assemblies includes a cylindrical filter bag. The filter bags are attached at a lower end portion to the thimbles. The filter bags extend upwardly in the outlet chamber and are attached at an upper end portion to support structure. The filter bags are generally connected to tensioning devices at the upper end portion.

Particulate-laden gas is introduced into the inlet chamber. The gas flows through the opening in the tubesheet, thimbles and filters into the outlet chamber. Particulates are separated from the gas stream by the filter bags. The filtered gas is exhausted from the outlet chamber or directed for other uses.

Important in the design of a filter bag and mounting structure is that a good seal must exist between the filter bag and its associated thimble. If a good seal does not exist, particulate-laden gas may leak between the filter bag and thimble into the outlet chamber. This leakage is an undesirable situation that renders the filter assemblies less effective.

Mounting the known filter bag typically includes sliding the lower end portion over the beaded thimble and sliding a cord reinforced portion axially away from a beaded portion of the thimble. A known stainless steel clamp is then installed about the lower end portion of the filter bag at a location between a cord portion of the filter bag and the beaded portion of the thimble. An adjusting portion of the clamp is then tightened to circumferentially contract the clamp into engagement with the lower end portion of the filter bag. The clamp is tightened a sufficient amount to force the lower end portion of the filter bag into sealing engagement against the outer surface of the thimble.

When the known filter bag mounting structure is used in corrosive environments it is prone to leakage problems. The leakage results from the clamp being contacted by corrosives in the gas stream that are typically encountered in certain industries and processes. The corrosives attack the metal material of the clamp so the clamp eventually fails. The force that the clamp exerted against the outer surface of the thimble is reduced and a good seal can no longer be maintained between the filter bag and the thimble.

### BRIEF DESCRIPTION OF THE INVENTION

The invention overcomes the disadvantages associated with the prior art filter mounting system. One aspect of the invention is directed to a filter assembly for use in a baghouse having a tubesheet with a plurality of thimbles. Each of the thimbles has a beaded portion. The filter assembly comprises a cylindrical filter bag having an axial end portion formed into a cuff. The cuff of the filter bag is adapted to be positioned within the thimble. The filter assembly also includes mounting structure adapted to be located within the cuff of the filter bag to mount the filter bag relative to a respective thimble of the tubesheet. The mounting structure includes an annular gasket located within the cuff of the filter bag. The gasket has a bead portion. The mounting structure also includes a resilient snapband for exerting a force against the gasket and seat the bead portion of the gasket within a beaded portion of the thimble to form a seal.

A cover is located about the cuff to protect the cuff during movement relative to the thimble. The mounting structure is attached to the cuff of the filter bag. The bead portion of the gasket is formed by a cord sewn into a fabric layer. The gasket is made from fabric and folded to encapsulate the snapband and maintain the snapband in engagement with the bead portion of the gasket.

Another aspect of the invention is directed to method of installing a filter assembly in a baghouse having a tubesheet with a plurality of thimbles. Each of the thimbles has a beaded portion. The method includes of removing a clamp holding a portion of an already installed filter bag on an outer surface of a thimble. The portion of the filter bag is removed from the outer surface of the thimble. A replacement filter assembly is provided. A compressive force is applied to a mounting structure of the replacement filter assembly to compress the mounting structure to a size smaller than the size defined by an inner surface of the thimble. The compressed mounting structure of the replacement filter assembly is inserted into an axial end of the thimble. The compressive force on the mounting structure of the replacement filter assembly is then released so an outer surface of the mounting structure of the replacement filter assembly engages the inner periphery of the thimble to mount the replacement filter bag assembly and form a seal against the thimble.

### BRIEF DESCRIPTION OF THE DRAWINGS

Further features of the invention will become apparent to those skilled in the art to which the invention relates from reading the following description with reference to the accompanying drawings, in which:

FIG. 1 is a schematic view, partly in section, of a baghouse with a filter assembly having mounting structure constructed according to the invention;

FIG. 2 is an enlarged cross-sectional view illustrating a portion of the baghouse of FIG. 1 illustrating a prior art filter mounting system attaching a filter bag to a beaded thimble of a tubesheet of the baghouse;

FIG. 3 is an enlarged cross-sectional view similar to FIG. 2, illustrating a portion of the filter mounting structure according to one aspect of the invention; and

FIG. 4 is an enlarged cross-sectional view of a portion of the filter mounting structure of FIG. 3 with parts separated for clarity.

### DETAILED DESCRIPTION OF THE INVENTION

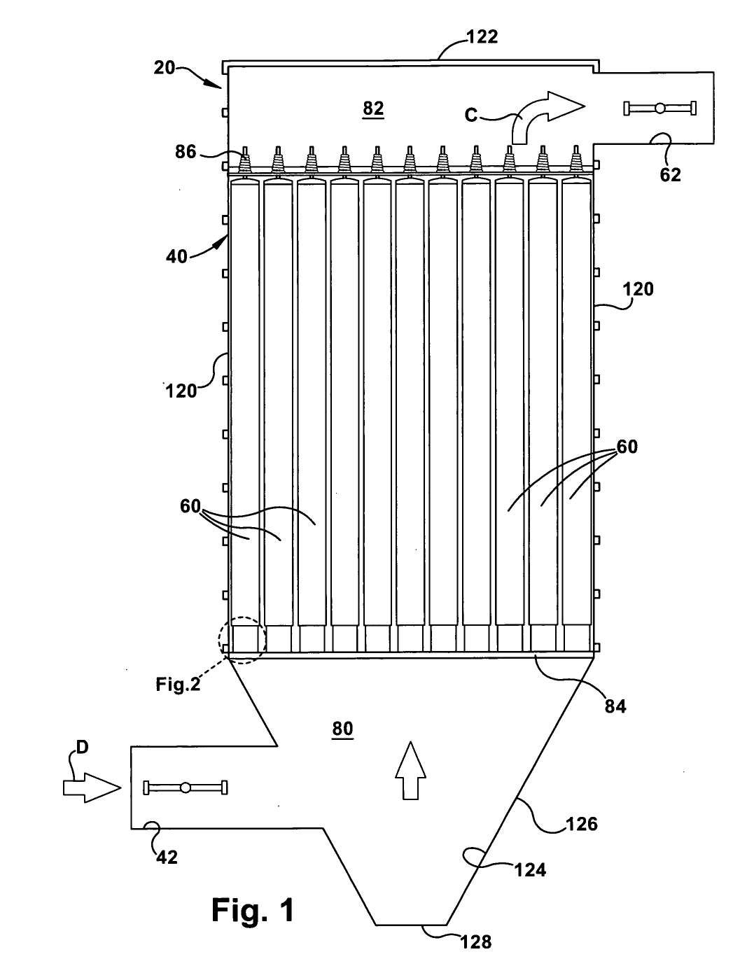

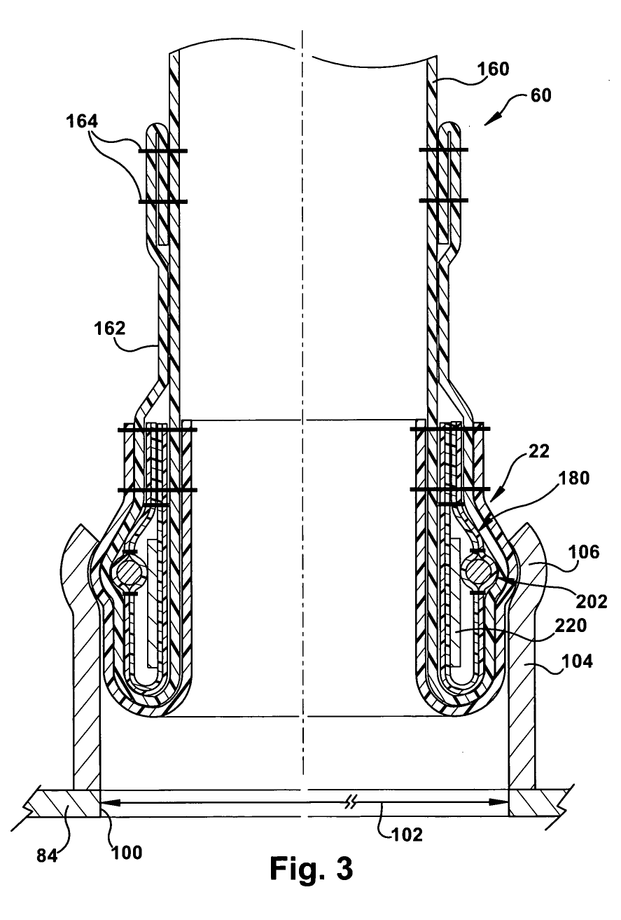

A reverse air baghouse 20 incorporating mounting structure 22 (FIG. 3) constructed according to one aspect of the invention is illustrated in FIG. 1. The baghouse 20 is defined by an enclosed housing 40. The housing 40 is made from a suitable material, such as sheet metal. Dirty or particulate-laden gas D enters the baghouse 20 through an inlet 42. The gas D may also contain corrosives.

The particulate-laden gas D is filtered by a plurality of filter assemblies 60 installed in the baghouse 20. Particulates are removed from the gas stream by the filter assemblies 60. The particulates are collected on the interior of filtration media of the filter assembles 60. Filtered gas C then flows from the filter assemblies 60 and exits the baghouse 20 through an outlet 62. Cleaning of the filter assemblies 60 occurs by a known “reverse air” procedure.

The baghouse 20 is divided into a inlet plenum 80 and an outlet plenum 82 by a tubesheet 84. The tubesheet 84 is made from a suitable material, such as a metal plate or sheet. The inlet 42 is in fluid communication with the inlet plenum 80. The outlet 62 is in fluid communication with the outlet plenum 82. The tubesheet 84 has at least a portion that is substantially planar and that mounts and supports the filter assemblies 60. The filter assemblies 60 are illustrated as extending a distance that approaches the length of the outlet plenum 82.

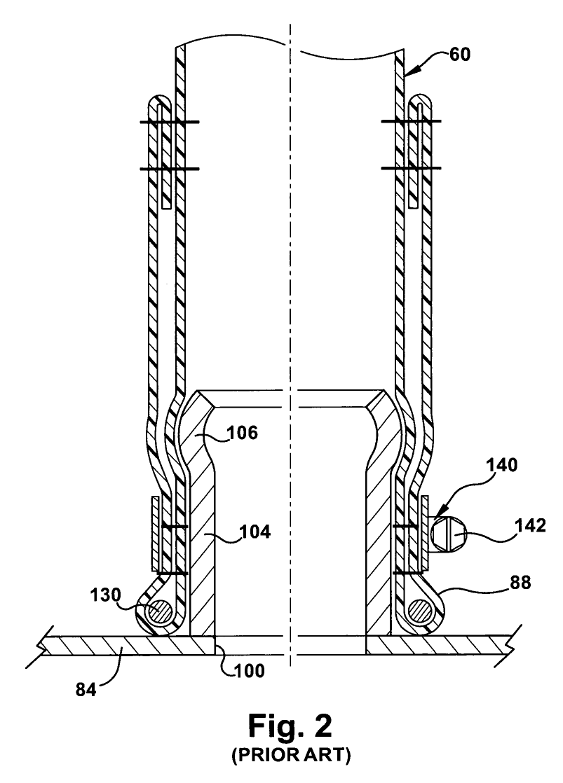

A plurality of circular openings 100 (FIGS. 2 and 3) extend through the planar portion of the tubesheet 84. Each opening 100 in the tubesheet 84 has an effective diameter, defined by the inner circumferential surface of the opening. A plurality of beaded thimbles 104 (FIGS. 2 and 3) are attached to the tubesheet 84, typically by welds. Each of the thimbles 104 has a substantially cylindrical shape with an inner diameter 102 (FIG. 3) the same as the opening 100. Each of the thimbles 104 also includes a beaded portion 106. The beaded portion 106 is formed in an axial end portion of the thimble 104 opposite the end attached to the tubesheet 84.

The beaded portion 106 of the thimble 104 is preferably formed so that it is located outside the diameter 102 of the inner circumferential of the opening 100 and thimble. The beaded portion 106 has an arcuate cross-sectional shape, as viewed in FIGS. 2-4. The beaded portion 106 of the thimble 104 receives a portion of the mounting structure 22 to locate and seal the filter assembly 60 relative to the thimble and tubesheet 84.

Each of the filter assemblies 60 is attached at a first axial end portion to a respective thimble 104. Each of the filter assemblies 60 is also attached at a second axial end portion to a tensioning device 86 (FIG. 1) mounted to the housing 40 of the baghouse 20.

The housing 40 (FIG. 1) of the baghouse 20 includes sides 120 and a roof 122. The baghouse 20 also has a dust accumulation area 124 defined by sloped walls 126 located at a lower end of the inlet plenum 80. Particles in the accumulation area 124 can be removed through the bottom region 128 of the accumulation area 124 of the baghouse 20.

Referring to FIG. 2, the known filter assembly 60 has a lower or first end portion 88 installed over the outer periphery of the thimble 104. The first end portion 88 of the known filter assembly 60 includes a cord 130. The first end portion 88 of the filter assembly 60 is located axially away from the beaded portion 106 of the thimble 104. A known stainless steel clamp 140 extends completely around the first end portion 88 of the filter assembly 60. The clamp 140 is located axially between the cord 130 and the beaded portion 106 of the thimble 104.

An adjusting portion 142 of the clamp 140 is then tightened to circumferentially contract the clamp into engagement around the first end portion 88 of the filter assembly 60. The clamp 140 is tightened a sufficient amount to force the first end portion 88 of the filter assembly 60 into sealing engagement against the outer surface of the beaded thimble 104.

When the known filter assembly 60 and clamp 140 are used in a corrosive environment leakage problems often occur. The leakage results from the clamp 140 being contacted by corrosives in the gas stream that are typically encountered in certain industries and processes. The corrosives attack the metal material of the clamp 140 so the clamp eventually fails. The force that the clamp 140 exerted against the first end portion 88 of the filter assembly 60 and the outer surface of the thimble 104 is reduced. A good seal is no longer maintained between the filter assembly 60 and the thimble 104. The seal is further compromised by the filter assembly 60 being located on the outside of the thimble and pressure acting on the inside of the filter assembly attempting to unseat it from the thimble.

The illustrated filter assemblies 60 according to one aspect of the invention are in the form of a “bag”. Each filter assembly 60 is supported at its lower end, as viewed in FIG. 1, by the tubesheet 84 at a beaded thimble 104, and extends upwardly in a substantially vertical direction. It will be apparent that the filter assemblies 60 may be oriented in any direction.

Each filter assembly 60 constructed according to one aspect of the invention includes a filter bag 160 (FIG. 3). Each filter bag 160 is formed into a substantially cylindrical shape. The filter bag 160 has a first axial end portion that is open and mounted to the beaded thimble 104. The filter bag 160 also has a second axially opposite end portion that is closed and attached to support structure of the housing 40 through a tensioning device 86.

The filter bag 160 may be made out of any suitable filtration media material for its intended application. Suitable filtration media materials for filtering corrosive gases is woven fiber glass or aramid fibers. The open end of the filter bag 160 is formed into a cuff 162 by turning an end of the filer bag material back onto itself. The turned back end of the filter bag 160 is attached by stitches 164 extending around the circumference of the filter bag.

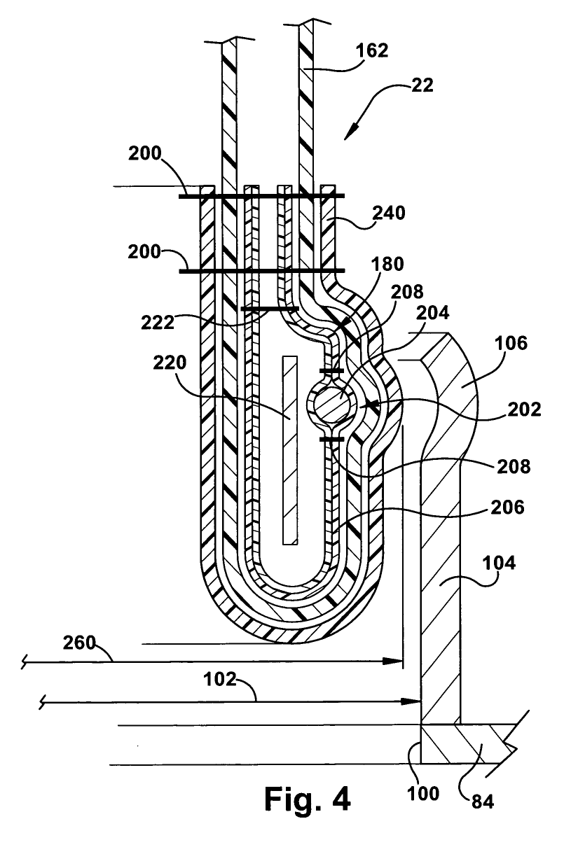

Each filter assembly 60 also includes the mounting structure 22 according to one aspect of the invention that eliminates the need for the known prior clamps 140 that are located on the exterior of the filter bag 160 and exposed to corrosive gas. The mounting structure 22 has a substantially annular shape. The mounting structure 22 has an annular gasket 180 (best seen in FIG. 4) that is adapted to be located within the cuff 162 of the filter bag 160. The mounting structure 22 mounts the filter assembly 60 relative to a respective thimble 104 of the tubesheet 84. The cuff 162 of the filter bag 160 is also adapted to be positioned at least partially within the axial extent of the thimble 104 when the filter assembly 60 is properly installed. The mounting structure 22 is preferably attached to the cuff 162 of the filter bag 160.

The gasket 180 is located within and attached to the cuff 162 of the filter bag 160 by stitches 200. The gasket 180 includes a bead portion 202. The bead portion 202 is sized so the mounting structure 22 fits and seals against the inner peripheral surface of the beaded portion 106 of the thimble 104.

The bead portion 202 of the gasket 180 is formed by placing a braided fiber glass cord 204 on textile fabric 206 material suitable for use in its intended environment. One such suitable material for the fabric 206 is woven fiber glass. The fabric 206 is folded over the cord 204 and stitches 208 hold the cord in place and prevent movement of the cord in an axial direction relative to the filter bag 160. The gasket 180 includes the bead portion 202 in the mounting structure 22 to locate, hold, and better seal the filter assembly 60 relative to the thimble 104.

The mounting structure 22 also includes a resilient snapband 220. The snapband 220 is made out of a suitable material, such as stainless steel. Opposite ends of the snapband 220 are attached together by suitable known mechanisms, such as by riveting (not shown), to form an annular member. The snapband 220 is located in the gasket 180 to exert force to expand the gasket outwardly and seat the bead portion 202 of the gasket within a beaded portion 106 of the thimble 104 to form a seal.

The gasket 180 is made from fabric 206 and folded to encapsulate the snapband 220 and maintain the snapband in engagement with the bead portion 202 of the gasket. The fabric 206 is folded to a dimension and fastened together at stitches 222 that to position the snapband 220 at an axial location within the gasket 180 next to the bead portion 202. This assures that the snapband 220 always exerts a force against the bead portion 202 to bias the bead portion and gasket 180 radially and circumferentially outward to expand the gasket and cuff 162.

The fabric 206 of the gasket 180 also adds a layer of material around the snapband 220. This provides additional protection of the material of the snapband 220 from any corrosive gas that could possibly damage the snapband.

A cover 240 is located about the cuff 162 of the filter bag 160. The cover 240 protects the cuff 162 and gasket 180 from excessive wear that may be encountered from a rough surface of the thimble 104 during movement of the cuff relative to the thimble. The cover 240 may be made out of any suitable material that is tough and durable. One such suitable material is woven polytetrafluoroethylene (PTFE) fibers. The cover 240 is wrapped around the cuff 162 of the filter bag 160. The cover 240 is attached to the cuff 162 by the stitches 200.

The cover 240 also adds an extra layer of protective material around the snapband 220. This provides additional protection of the material of the snapband 220 from any corrosive gas that could damage the snapband.

The force exerted by the snapband 220 against the bead portion 202 of the gasket 180 and cover 240 forms a seal against the thimble 104. The size of the bead portion 202 of the gasket 180 is selected to fit tightly within the beaded portion 106 of the thimble 104. The force exerted by the snapband 220 and the positive pressure within the inlet plenum 80 forces the gasket 180 to maintain the mounting structure 22 and filter assembly 60 in sealing engagement with, and positioned within, the thimble 104. This assures that the filter assembly 60 will not detach from the thimble 104 and that no leakage occurs between the filter assembly and thimble. The force required to detach the filter assembly 60 and mounting structure 22 from the thimble 104 is greater than the forces exerted on the filter bag 160 due to the tensioning device 86 and cleaning cycles during operation.

A method of installing a filter assembly 60 in a baghouse 20 according to another aspect of the invention is described below. The result of this method overcomes the disadvantages of known filter bag clamps 140 failing and allowing leakage between the known filter bag mounting arrangements and associated thimbles 104. Also, installation of the filter assembly 60 and mounting structure 22 according to this aspect of the invention is simplified relative to known filter bag mounting arrangements.

The method includes the step of removing the known filter assembly 60, as illustrated in FIG. 2, that is already installed in the baghouse 20. This step involves removing the clamp 140 holding a portion of an already installed filter assembly 60 on an outer surface of a thimble 104. The portion of the installed filter assembly 60 is then removed from the outer surface of the thimble 104. Any maintenance that is required on the thimble 104 or tubesheet 84 is done at this time. It may be found that the tubesheet 84 or thimble 104 suffer from corrosion and/or abrasion due to the environment it is in. In some instances a new tubesheet 84 with thimbles 104 is provided.

A replacement filter assembly 60 constructed according to one aspect of the invention described above is provided for installation. Mounting structure 22 according to one aspect of the invention described above is attached to the replacement filter assembly 60. The mounting structure 22 includes the gasket 180, snapband 220 and cover 240, as described above.

A compressive force is applied to the mounting structure 22 of the replacement filter assembly 60. This force compresses the mounting structure 22 to a size 260 (FIG. 4) that is smaller than the size of the diameter 102 defined by an inner surface of the opening 100 and thimble 104. The compressed mounting structure 22 of the replacement filter assembly 60 is inserted into an upper axial end of the thimble 104, as reviewed in FIG. 4, so the bead portion 202 of the gasket 180 is axially aligned with the beaded portion 106 of the thimble 104.

The compressive force on the mounting structure 22 of the replacement filter assembly 60 is then released. An outer surface of the mounting structure 22 of the replacement filter assembly 60 engages the inner periphery of the thimble 104 to mount the replacement filter assembly 60 and form a seal. The bead portion 202 of the gasket 180 in the mounting structure 22 is received in a beaded portion 106 of the thimble 104 to form a further seal. The bead portion 202 of the gasket 180 being received in the beaded portion 106 of the thimble 104 also inhibits axial movement of the mounting structure 22 of the filter assembly 60 relative to the thimble.

The force exerted by the snapband 220 against the bead portion 202 of the gasket 180 and cover 240 forms a seal against the inner surface of the thimble 104. The size of the bead portion 202 of the gasket 180 is selected to fit tightly within the beaded portion 106 of the thimble 104. The force exerted by the snapband 220 and the positive pressure within the inlet plenum 80 forces the gasket 180 to maintain the mounting structure 22 within the thimble 104. This assures that the filter assembly 60 will not detach from the thimble 104 and that no leakage occurs between the filter assembly and thimble.

From the above description of at least one preferred embodiment of the invention, those skilled in the art will perceive improvements, changes and modifications. Such improvements, changes and modifications within the skill of the art are intended to be covered by the appended claims.

1. A filter assembly for use in a baghouse having a tubesheet with a plurality of thimbles each having a beaded portion, said filter assembly comprising:
a cylindrical filter bag having an axial end portion formed into a cuff, said cuff of said filter bag adapted to be positioned within the thimble; and
mounting structure adapted to be located within said cuff of said filter bag to mount said filter bag assembly relative to a respective thimble of the tubesheet, said mounting structure comprising:
an annular gasket including a bead portion; and
a resilient snapband for exerting a force to expand the gasket outward and seat the bead portion of said gasket within a beaded portion of the thimble to form a seal.

2. The filter assembly of claim 1 further including a cover located about said cuff to protect the cuff during movement relative to the thimble.

3. The filter assembly of claim 1 wherein said mounting structure is attached to said cuff of said filter bag.

4. The filter assembly of claim 1 wherein said bead portion of said gasket is formed by a cord sewn into a fabric layer.

5. The filter assembly of claim 1 wherein said gasket is made from fabric and folded to encapsulate said snapband and maintain said snapband in engagement with said bead portion of said gasket.

6. A filter assembly for use in a baghouse having a tubesheet with a plurality of thimbles each having a beaded portion, said filter assembly comprising:
a filter bag; and
mounting structure adapted to be located within an end portion of said filter bag to mount said filter assembly relative to a respective thimble of the tubesheet, said mounting structure also adapted to be positioned within the thimble and comprising:
a gasket including a bead portion; and
a resilient snapband adapted to be located within said gasket for exerting a force to expand said gasket outward and seat the bead portion of said gasket within a beaded portion of the thimble.

7. The filter assembly of claim 6 wherein said mounting structure is attached to said filter bag.

8. The filter assembly of claim 6 wherein said filter bag has a substantially cylindrical shape.

9. The filter assembly of claim 8 wherein said gasket and said snapband each have a substantially annular shape.

10. The filter assembly of claim 6 wherein said bead portion of said gasket is formed by a cord sewn into a fabric layer.

11. The filter assembly of claim 10 wherein said gasket is made from fabric and folded to encapsulate said snapband and maintain said snapband in engagement with said bead portion of said gasket.

12. The filter assembly of claim 6 further including a cover adapted to be disposed between said gasket and the thimble.

13. A method of installing a filter assembly in a baghouse having a tubesheet with a plurality of thimbles each having a beaded portion, said method comprising the steps of:
providing a filter assembly comprising a filter bag;
applying a compressive force to a mounting structure of the filter assembly to compress the mounting structure to a size smaller than the size defined by an inner surface of the thimble;
inserting the compressed mounting structure of the filter bag assembly into an axial end of the thimble; and
releasing the compressive force on the mounting structure of the filter assembly so an outer surface of the mounting structure of the filter assembly engages the inner periphery of the thimble to mount the filter bag assembly and form a seal.

14. The method of claim 13 further including removing steps being performed prior to said providing step, said removing steps comprising:
removing a clamp holding a portion of an already installed filter bag on an outer surface of a thimble; and
removing the portion of the filter bag from the outer surface of the thimble.

15. The method of claim 13 further including the step of providing a bead portion in the mounting structure for reception in a beaded portion of the thimble.

16. The method of claim 13 wherein said providing step includes the step of providing the filter bag with the mounting structure attached.

17. The method of claim 13 wherein said providing step includes the step of providing a filter bag that has a substantially cylindrical shape.

18. The method of claim 17 wherein said providing step includes the step of providing a mounting structure that includes a gasket and a snapband that each have a substantially annular shape.

19. The method of claim 13 wherein said providing step includes the step of providing a cover located outside the mounting structure.

20. The method of claim 13 wherein said providing step includes the step of providing a gasket that is folded to encapsulate a snapband and maintain the snapband in engagement with a bead portion of the gasket.
